(19) United States
(12) Patent Application Publication
(10) Pub. No.: US 2023/0185561 A1
(43) Pub. Date: Jun. 15, 2023

(54) VIRTUAL APPLIANCE FUNCTIONALITY TRANSFORMATIONS

(71) Applicant: VMWARE, INC., Palo Alto, CA (US)

(72) Inventors: Vinothkumar D, Bangalore (IN); VINEETH TOTAPPANAVAR, Bangalore (IN); RAHUL SINGH, Bangalore (IN); AKANSHA SRIVASTAVA, Bangalore (IN); ABHISHEK SINGH, Bangalore (IN)

(21) Appl. No.: 17/865,444

(22) Filed: Jul. 15, 2022

Related U.S. Application Data
(63) Continuation-in-part of application No. 17/549,942, filed on Dec. 14, 2021.

(51) Int. Cl. G06F 8/65; G06F 8/61

(52) U.S. Cl. CPC G06F 8/65; G06F 8/61

(57) ABSTRACT

In an example, a request to upgrade a first virtual appliance having a first functionality in a data center to a second virtual appliance having a second functionality may be received. Further, an operating system of the first virtual appliance may be modified based on a specification of the second virtual appliance. Furthermore, a system variable may be provisioned in a persistent storage location accessible to the first virtual appliance based on the specification of the second virtual appliance. Also, an application specific package associated with the second functionality may be installed in the first virtual appliance. The first virtual appliance may be transformed to the second virtual appliance using the modified operating system, the provisioned system variable, and the application specific package.

### RELATED APPLICATION

This application is a Continuation-in-part of patent application Ser. No. 17/549,942 entitled “ON-PREMISES TO CLOUD MIGRATION OF ENDPOINT PERFORMANCE MONITORING”, filed on Dec. 14, 2021, by VMware, Inc., which is herein incorporated in its entirety by reference for all purposes.

### TECHNICAL FIELD

The present disclosure relates to computing environments, and more particularly to methods, techniques, and systems for transforming virtual appliance functionalities in a data center.

### BACKGROUND

Virtualization allows the abstraction of hardware resources and the pooling of these resources to support multiple virtual appliances (e.g., virtual machines) in a virtualized computing environment. For example, through virtualization, virtual machines running different operating systems may be supported by the same physical machine (e.g., referred to as a “host”). Each virtual machine may be provisioned with virtual resources that provide similar functions as the physical hardware of the host, such as central processing unit (CPU) resources, memory resources, storage resources and network resources to run an operating system and applications. The storage resources may be required by a virtual machine to store data relating to the operating system and applications run by the virtual machine.

In such virtualized computing environments, two virtual machines may perform similar functions but with different components and modules. In an example, two virtual appliances serving a similar function may be available due to different base platforms or infrastructures. Consider an example performance monitoring tool, application or platform (e.g., VMware® vRealize Operations (vROps)), which may include a first virtual appliance (i.e., an application remote collector (ARC)) and a second virtual appliance (i.e., a cloud proxy). Both the first virtual appliance and the second virtual appliance perform application performance monitoring. For example, the first virtual appliance may act as the ARC to monitor an endpoint (e.g., a physical machine, a virtual machine, a container, or the like) and send monitored information to a first monitoring application running in an on-premises server. Further, the second virtual appliance may act as the cloud proxy to monitor the endpoint and send monitored information to either the first monitoring application or a second monitoring application running in a cloud-based server (e.g., a Software as a service (SaaS) platform). Both the ARC and the cloud proxy may require different hardware configurations and operating system versions. In this example, even though both the ARC and the cloud proxy may perform similar function (i.e., agent-based application performance monitoring of the endpoint), the cloud proxy may offer plethora of advantages over the ARC.

### BRIEF DESCRIPTION OF THE DRAWINGS

FIG. 1 is a block diagram of an example system, depicting a management node to transform a first application running in a virtual appliance to a second application;

FIG. 2A is a sequence diagram illustrating a sequence of events to transform a first application (e.g., an application remote collector (ARC)) running in a virtual appliance to a second application (e.g., a cloud proxy);

FIG. 2B shows an example data center, depicting transformation of an ARC to a cloud proxy to migrate application performance monitoring from an on-premises platform to a cloud platform;

FIG. 3 is a flow diagram, illustrating an example method for transforming a first virtual appliance having a first functionality to a second virtual appliance having a second functionality in a data center;

FIG. 4 is a flow diagram, illustrating another example method for transforming a first virtual appliance having a first functionality to a second virtual appliance having a second functionality in a data center; and

FIG. 5 is a block diagram of an example management node including non-transitory computer-readable storage medium storing instructions to transform a first application running in a virtual appliance to a second application.

The drawings described herein are for illustrative purposes and are not intended to limit the scope of the present subject matter in any way.

### DETAILED DESCRIPTION

Examples described herein may provide an enhanced computer-based and/or network-based method, technique, and system to transform virtual appliance functionalities in a computing environment. Computing environment may be a physical computing environment (e.g., an on-premises enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. The virtual computing environment may include multiple physical computers executing different workloads (e.g., virtual machines, containers, and the like). Such workloads may execute different types of applications.

The paragraphs [0012] to [0017] present an overview of the virtual environment, existing methods to upgrade functionality of a virtual appliance, and drawbacks associated with the existing methods. In an example virtual environment, multiple virtual machines may perform a similar function but with different components and modules. For example, a performance monitoring application or platform, such as VMware® vRealize Operations (vROps), may include two virtual appliances namely, an application remote collector (ARC) and a cloud proxy. Both the virtual appliances may perform application performance monitoring (APM). In this example, a first virtual appliance may act as the ARC to monitor an endpoint (e.g., a physical machine, a virtual machine, a container, or the like) and send monitored information to a first monitoring application running in an on-premises server using a monitoring agent. The term “on-premises” may refer to a software and a hardware infrastructural setup (e.g., associated with the monitoring tools) deployed and running from within the confines of an organization/enterprise. In this example scenario, the endpoint may include the monitoring agent (e.g., Telegraf™, Collectd, Micrometer, and the like) to collect performance metrics from the endpoint and provide, via a network, the collected performance metrics to the ARC. Further, the ARC may receive the performance metrics from the monitoring agent and transmit the performance metrics to the first monitoring application for metric analysis. Furthermore, the first monitoring application may receive the performance metrics, analyse the received performance metrics, and display the analysis in a form of dashboards, for instance. The displayed analysis may facilitate in visualizing the performance metrics and diagnose a root cause of issues, if any.

Further, a second virtual appliance may act as a cloud proxy to monitor the endpoint and send the monitored information to the first monitoring application or a second monitoring application running in a cloud-based server using the monitoring agent. In this example, the second monitoring application may be deployed and run-in cloud platforms (e.g., Software as a service (SaaS) platforms) to collect data from the endpoint via the cloud proxy. The SaaS is a software distribution model in which a cloud provider hosts applications and makes the applications available to end users over the Internet.

Thus, the first virtual appliance and the second virtual appliance both may perform application performance monitoring. However, the cloud computing and the SaaS may offer a plethora of advantages over the on-premises environment, viz. replacing capital expenditures with operating expenses, no upfront costs, subscription-based pricing, and the like. The cloud computing and the SaaS have changed software consumption, software development, and support processes. This is due to the fact that in the SaaS model the software applications (e.g., the monitoring tools) are hosted by a service provider and/or a vendor and may not be deployed on customer's premises. This specific delivery model may be considered as an enabler for a different approach to software development and support users. Hence, customers may have to be provided with a hassle-free approach of application performance monitoring migration from the on-premises platform to the SaaS platform.

To migrate or transform the first functionality (e.g., the ARC) of the first virtual appliance to the second functionality (e.g., the cloud proxy), multiple factors may have to be considered. For example, the ARC and the cloud proxy are two different virtual appliances running on different versions of operating systems (e.g., Photon operating systems). The ARC may run on Photon operating system version 1.0 whereas the cloud proxy may run on Photon operating system version 3.0. Further, hardware configurations can be different for both the virtual appliances. For example, the ARC may need a hardware configuration of 4 GB for processing capacity and 40 GB for storage capacity and the cloud proxy may need a hardware configuration of 2 GB for processing capacity and 84 GB for storage capacity.

An existing method to transform the functionalities of the virtual appliance (e.g., from the first virtual appliance to the second virtual appliance, i.e., performance monitoring from the on-premises platform to the cloud platform) may include a “start from scratch” approach, where both the remote collector and the monitoring agents on the endpoints (e.g., virtual machines) undergo a fresh/new installation. However, this approach may result in a potential loss of historical data that can occur due to fresh installation of the monitoring agents. This approach may also result in a downtime in monitoring, which may be incurred due to performing the fresh installation of the remote collector and the monitoring agents.

In other example methods, configuration files and data from a first virtual appliance (i.e., a source virtual application) are copied to a second virtual appliance (i.e., a target virtual appliance). In this example, the target virtual appliance is deployed afresh with instance specific configurations. Further, a new communication channel with the target virtual appliance may be set by updating all the directly connected compute nodes in the data center. Subsequently, the existing communication channel is brought down or deactivated. However, the method may include manual steps which may hinder automation and impact scalability of the approach. Further, the process involves copying of files, which may be contingent on the environment size. As the size increases, the number of files to be copied also increases, thus increasing the overall time and propensity of copy-error to creep in. Furthermore, an additional step of validation may have to be carried out to ascertain whether the target virtual appliance and updated nodes are connected. The nodes in the existing setup are directly connected to the source virtual appliance. Thus, in this method, there can be down time and internet protocol (IP) update overheads involved in setting up new connections. Also, in both the approaches, the need for an additional virtual machine/hardware to start with can be an added burden.

Examples described herein may provide a hassle-free and in-place upgrade approach to transform an existing virtual appliance having a first functionality to a target virtual appliance having a second functionality without a need to deploy a new/additional virtual appliance. For example, the existing virtual appliance with the first functionality may be an ARC and the target virtual appliance with the second functionality may be a cloud proxy.

In an example, a system may include a virtual appliance having a first functionality and a management node. During operation, the management node may modify a hardware configuration and an operating system of a virtual appliance (e.g., having a first functionality) based on a specification of a second application. Further, the management node may provision a system variable in a persistent storage location accessible to the virtual appliance based on the specification. Further, the management node may install an application specific package associated with the second application in the virtual appliance. Furthermore, the management node may transform the first application to the second application using the modified hardware configuration, the modified operating system, and the application specific package. Further, the virtual appliance, upon reboot, may perform a second functionality.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

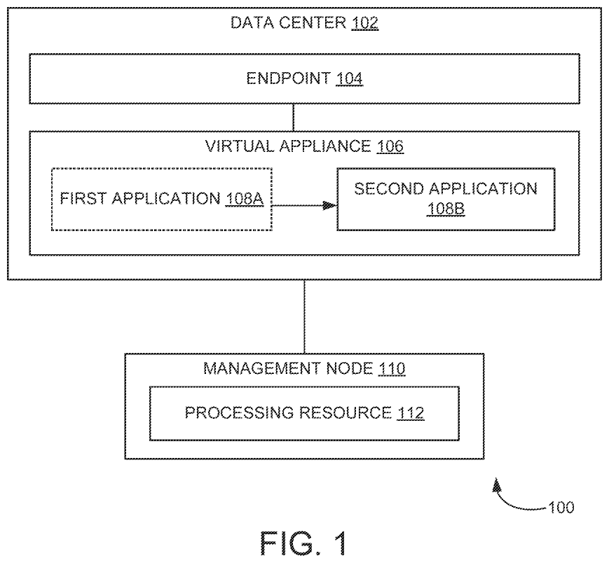

FIG. 1 is a block diagram of an example system 100, depicting a management node 110 to transform a first application 108A running in a virtual appliance 106 to a second application 108B. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 may include a data center 102 having multiple compute nodes (e.g., an endpoint 104 and virtual appliance 106). Example virtual appliance 106 may include, but not limited to, a virtual machine, a container, or any other virtual computing instance that executes different applications. Example endpoint 104 may include, but not limited to, a virtual machine, a physical host computing system, a container, or any other computing instance that executes different applications. For example, endpoint 104 can be deployed either in an on-premises platform or an off-premises platform (e.g., a cloud managed software defined data center (SDDC)). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

In an example, virtual appliance 106 may execute first application 108A to perform a first function corresponding to endpoint 104. For example, virtual appliance 106 with first application 108A acts as an application remote collector (ARC) to monitor endpoint 104 and communicate monitored information to a first monitoring application running in an on-premises server. In this example, endpoint 104 may include a monitoring agent to monitor endpoint 104. The monitoring agent may be installed in endpoint 104 to fetch the metrics from various components of endpoint 104. For example, the monitoring agent may real-time monitor endpoint 104 to collect the metrics (e.g., telemetry data) associated with an application or an operating system running in endpoint 104. An example monitoring agent may include Telegraf agent, Collectd agent, or the like. Example metrics may include performance metric values associated with at least one of central processing unit (CPU), memory, storage, graphics, network traffic, or the like. Further, the ARC may receive the performance metrics or the monitored information from the monitoring agent and ingest the monitored information to the first monitoring application for performance analysis.

Further, example system 100 may include management node 110 to manage data center 102. For example, management node 110 may execute centralized management services that may be interconnected to manage the resources centrally in the virtualized computing environment. Example centralized management service may be enabled by vCenter Serverυ and vSphere® program products, which are VMware's cloud computing virtualization platforms. In an example, management node 110 may be communicatively connected to data center 102 via a network to manage data center 102. An example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Furthermore, management node 110 may include a processing resource 112. Processing resource 112 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processing resource 112 may, for example, include single or multiple cores on a chip, multiple cores across multiple chips, multiple cores across multiple devices, or suitable combinations thereof. Processing resource 112 may be functional to fetch, decode, and execute instructions as described herein.

During operation, processing resource 112 may receive a request to transform first application 108A in virtual appliance 106 to second application 1088. In case of an example application performance monitoring, processing resource 112 may receive a request to migrate endpoint performance monitoring from an on-premises platform to a cloud platform. For example, virtual appliance 106 with second application 108B acts as a cloud proxy to monitor endpoint 104 and communicate the monitored information to the first monitoring application running in the on-premises server or a second monitoring application running in a cloud-based server. In this example, the cloud proxy receives the monitored information from the monitoring agent running in endpoint 104 and ingest the monitored information to the first monitoring application or the second monitoring application for performance analysis. To migrate the endpoint performance monitoring from the on-premises platform to the cloud platform, the ARC that communicates with on-premises' based monitoring application has to be upgraded or transformed to the cloud proxy that communicates with a cloud-based monitoring application.

To upgrade or transform first application 108A (e.g., the ARC) to second application 108B (e.g., the cloud proxy), processing resource 112 may modify a hardware configuration and an operating system of virtual appliance 106 based on a specification of second application 108B. In an example, processing resource 112 may provision an additional storage resource to virtual appliance 106 based on a hardware requirement of second application 108B.

In an example, processing resource 112 may modify the operating system by modifying (e.g., upgrading or downgrading) a version of the operating system based on the specification of second application 108B. In this example, processing resource 112 may deploy an operating system upgrade package associated with a second version of the operating system on virtual appliance 106. Further, processing resource 112 may modify the operating system of virtual appliance 106 from a first version that supports first application 108A to the second version that supports second application 108B according to the operating system upgrade package. In this example, processing resource 112 may upgrade or downgrade the operating system from the first version to the second version without hopping on intermediate versions.

In another example, processing resource 112 may modify the operating system by deploying an operating system installation package associated with another operating system on virtual appliance 106 based on the specification of second application 108B. Further, processing resource 112 may transform the operating system of virtual appliance 106 that supports first application 108A to the other operating system that supports second application 108B according to the operating system installation package.

Further, processing resource 112 may provision a system variable in a persistent storage location accessible to virtual appliance 106 based on the specification. A system variable or environment variable may refer to a value that impacts the processes and behavior of running virtual appliance 106 and OS environments. Running programs may access environment variable values for configuration purposes.

In an example, processing resource 112 may provision the system variable by determining the system variable or the system variable with a different value required to execute second application 108B based on the specification of second application 108B. Further, processing resource 112 may store the system variable or the system variable with the different value in the persistent storage location accessible to virtual appliance 106. For example, the system variable can include a one-time key to establish a secure communication for second application 108B upon transforming first application 108A to second application 108B.

Furthermore, processing resource 112 may install an application specific package (e.g., an installation script) associated with second application 108B in virtual appliance 106. Further, processing resource 112 may transform first application 108A to second application 108B using the modified hardware configuration, the modified operating system, and the application specific package. Further, processing resource 112 may uninstall and delete an installation package associated with first application 108A upon transforming first application 108A to second application 108B.

Further, processing resource 112 may reboot virtual appliance 106. In an example, virtual appliance 106, upon reboot, is to execute second application 108B to perform a second function corresponding to endpoint 104 using the provisioned system variable. In an example, processing resource 112 may download a boot image and a boot program associated with second application 108B to virtual appliance 106. Further, processing resource 112 may reboot virtual appliance 106 using the boot image and the boot program associated with second application 108B. In the example of the application performance monitoring, upon reboot, first application 108A that communicates with on-premises' based monitoring application (i.e., the first monitoring application) is transformed to second application 108B that communicates with a cloud-based monitoring application (i.e., the second monitoring application). Further, a secure communication may be established between second application 108B and the second monitoring application based on the system variable.

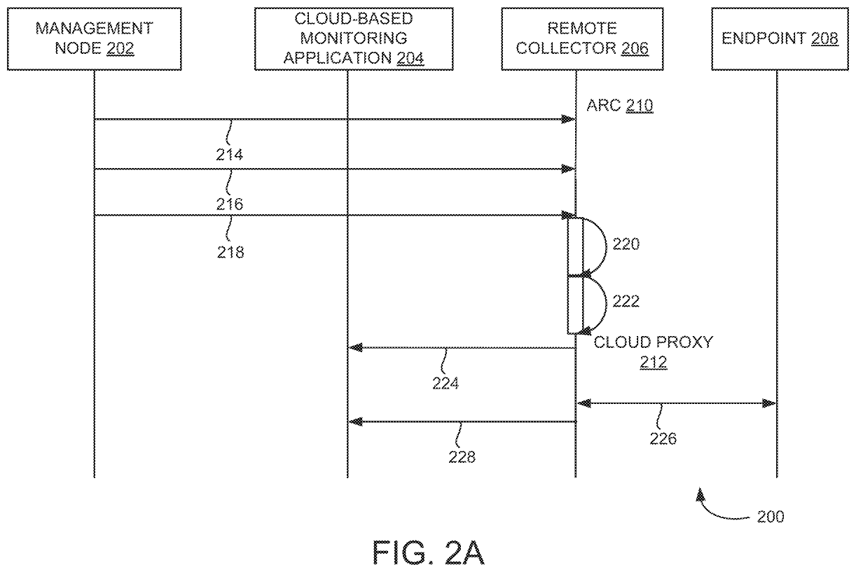

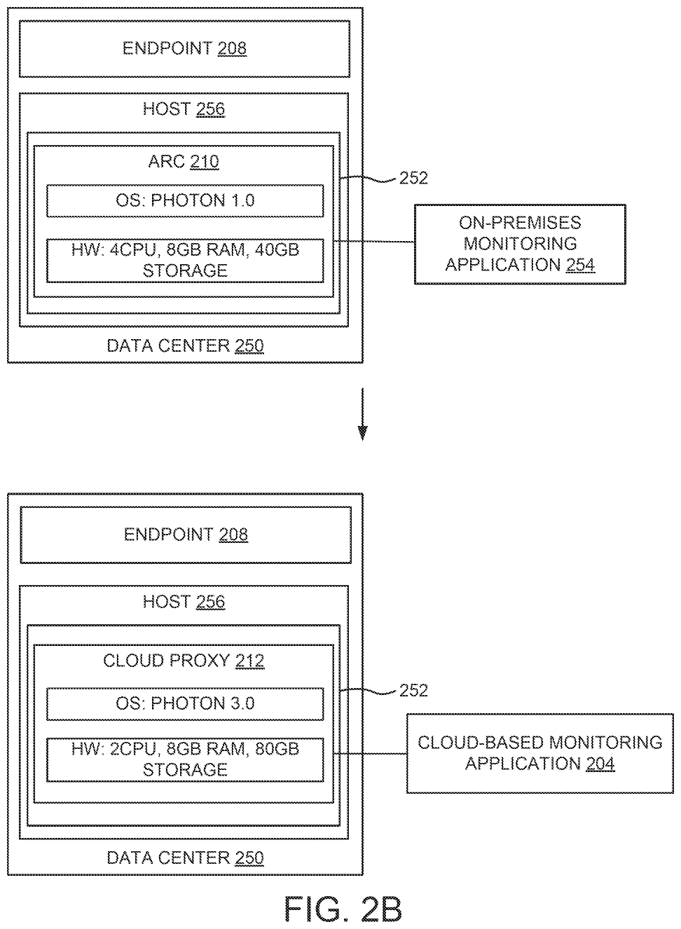

FIG. 2A is a sequence diagram 200 illustrating a sequence of events to transform a first application (e.g., an ARC 210) running in a virtual appliance (e.g., a remote collector 206) to a second application 212 (e.g., a cloud proxy 212). The sequence diagram 200 may represent the interactions and the operations involved in upgrading a remote collector 206 to migrate application performance monitoring from an on-premises platform to a cloud platform. FIG. 2A illustrates process objects including a management node 202, a cloud-based monitoring application 204, remote collector 206, and an endpoint 208 along with their respective vertical lines originating from them. The vertical lines of management node 202, cloud-based monitoring application 204, remote collector 206, and endpoint 208 may represent the processes that may exist simultaneously. The horizontal arrows (e.g., 214, 216, 218, 224, 226, and 228) may represent the process/sequence flow steps between the vertical lines originating from their respective process objects (for e.g., management node 202, cloud-based monitoring application 204, remote collector 206, and endpoint 208). Further, activation boxes (e.g., 220 and 222) between the horizontal arrows may represent the process that is being performed in the respective process object.

For example, endpoint 208 can be a physical host computing system, a virtual machine, or a container. Further, remote collector 206 may communicate with endpoint 208 to collect the performance metrics and transmit the performance metrics to an on-premises-based monitoring application (e.g., vROps) for analysis. In an example, remote collector 206 may be ARC 210. Example management node 202 (e.g., vCenter) may upgrade ARC 210 to cloud proxy 212 to migrate application performance monitoring from the on-premises platform to the cloud platform (e.g., as shown in 214, 216, 218, 220, 222, 224, 226, and 228).

At 214, a hardware configuration (e.g., a storage resource) and an operating system of remote collector 206 may be modified based on a specification (e.g., a system requirement) of cloud proxy 212. FIG. 2B shows an example data center 250, depicting transformation of ARC 210 to cloud proxy 212 to migrate application performance monitoring from the on-premises platform to the cloud platform. As shown in FIG. 2B, ARC 210 may run in a virtual appliance 252. An example virtual appliance 252 is a virtual machine running on a host computing system 256. In this example, the additional storage resource may be provisioned to virtual appliance 252 from host computing system 256. In the example shown in FIG. 2B, to migrate ARC 210 to cloud proxy 212, resource specification of virtual appliance 252 may be considered. For example, the resource specification for ARC 210 and required resource specification to install cloud proxy 212 is shown in below Table 1.

TABLE 1

| Resource | ARC | Cloud Proxy |
|---|---|---|
| vCPU | 4 | 2 |
| Memory | 8 GB | 8 GB |
| Hard Disk | 40 GB (30 + 10) | 84 GB (20 + 60 + 4) |

As shown in table 1, virtual appliance 252 may require additional 44 GB of hard disk with specified partitions (e.g., 20+60+4). Thus, additional 44 B may be provisioned to virtual appliance 252.

Further, the operating system of virtual appliance 252 may be upgraded from a first version that supports ARC 210 to the second version that supports cloud proxy 212 according to an operating system upgrade package corresponding to cloud proxy 212. For example, each version of the operating system may include multiple dependency packages to carry out operating system functionalities and user applications. Further, the versions of such packages may be upgraded for security reasons or for new features. In some examples, providers of the operation system may recommend upgrading the operating system from a current version to a next version and not to hop directly to the latest version to ease maintenance of a release version and to avoid package management issues. Since package management of each operating system version is independent, there may be a chance that a version of some packages in older operating system version may be greater than that of a latest operating system version.

In the example shown in FIG. 2B, ARC 210 runs on Photon operating system 1.0 and cloud proxy 212 runs on Photon operating system 3.0. On upgrading Photon operating system from 1.0 to 3.0 without hopping on intermediate version (2.0), afore mentioned package version issue may be considered. For example, the version of glib and dbus packages on 1.0 may be greater than the version of glib and dbus packages on 3.0. The operating system upgrade package described above may facilitate to apply changes on existing versions and not to be tested for dependency. Similarly, the operating system can also be changed from one operating system to another operating system using an operating system installation package.

Referring back to FIG. 2A, at 216, a system variable may be provisioned in a persistent storage location accessible to remote collector 206 based on the specification of cloud proxy 212. For example, connection information of remote collector 206 may be configured. In the example of FIG. 2B, connection information may include a one-time key (i.e., the system variable) generated during the installation of cloud proxy 212 on virtual appliance 252. With the connection information, upon rebooting virtual appliance 252, a secure communication may be established between cloud proxy 212 and cloud-based monitoring application 204 based on the one-time key. For example, cloud proxy 212 may be capable of connecting to cloud-based monitoring application 204 based on the one-time key set during the installation of cloud proxy 212. In an example, the one-time key may be manually set on virtual appliance 252.

Referring back to FIG. 2A, at 218, an application specific package associated with cloud proxy may be installed in remote collector 206. At 220, remote collector 206 may be upgraded to cloud proxy 212 using the modified hardware configuration, the modified operating system, the provisioned system variable, and the application specific package. In the example of FIG. 2B, ARC 210 may be upgraded to cloud proxy 212 using a web-based management interface. For example, the web-based management interface may be enabled by vCenter server appliance management interface (VAMI), which is an administration Web interface to perform basic administrative tasks for the appliance configuration. The VAMI may update virtual appliance 252 to the build (e.g., upgraded hardware configuration, upgraded operating system, and the connection information) provided. For example, the VAMI may first update the operating system, then operating system packages, and user packages. Further, components (e.g., Salt, EMQTT, Nginx, UCPAPI server, and the like) associated with ARC 210 may be packaged as a red hat package (RPM) package and installed on virtual appliance 252. Components (e.g., Salt, Apache, libraries, and the like) associated with cloud proxy 212 may be packaged as RPM package. Further, to upgrade ARC 210 to cloud proxy 212, the ARC RPM package may be uninstalled and cleared. Further, cloud proxy RPM package may be installed to have files and components of cloud proxy 212 in virtual appliance 252. Also, cloud proxy contents and boot scripts (e.g., cloud proxy iso) may be downloaded and mounted.

Referring back to FIG. 2A, at 222, remote collector 206 may be rebooted to enable cloud proxy 212 to communicate with endpoint 208 and cloud-based monitoring application 204. In the example of FIG. 2B, upgrading ARC 210 using the VAMI may install/upgrade the files and directories on virtual appliance 252. The updated files may be stored on disk of virtual appliance 252. Further, to choose the updated files and components of cloud proxy 212, processes in virtual appliance 252 may be restarted. Restarting virtual appliance 252 may load the updated files from a secondary storage to a main memory and use for execution. In an example, a user may be prompted to reboot virtual appliance 252. In another example, virtual appliance 252 may be dynamically rebooted after upgrading from ARC 210 to cloud proxy 212. Also, since the additional storage resource is provisioned in virtual appliance 252, when virtual appliance 252 is rebooted, cloud proxy 212 may be selected for execution.

At 224, cloud proxy 212 may communicate with cloud-based monitoring application 204 upon rebooting. At 226, cloud proxy 212 may collect the metrics from endpoint 208 and transmit the metrics to cloud-based monitoring application 204, at 228. Thus, examples described herein may reduce the burden of manual interventions or reinstall of agents to migrate application performance monitoring from an on-premises platform (e.g., an on-premises monitoring application 254 of FIG. 2B) to a cloud platform (e.g., cloud-based monitoring application 204, i.e., SaaS application). Thus, examples described herein may provide a hassle free in-place upgrade of one virtual appliance to another virtual appliance.

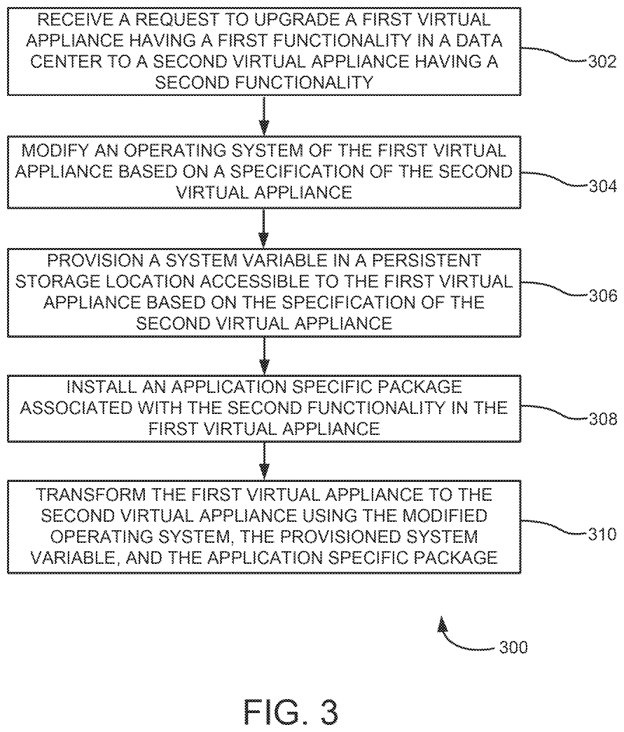

FIG. 3 is a flow diagram, illustrating an example method 300 for transforming a first virtual appliance having a first functionality to a second virtual appliance having a second functionality in a data center. At 302, a request to upgrade a first virtual appliance having a first functionality in a data center to a second virtual appliance having a second functionality may be received. For example, the first virtual appliance having the first functionality includes an application remote collector to monitor an endpoint in the datacenter and send monitored information to a first monitoring application running in an on-premises server. Further, the second virtual appliance having the second functionality may include a cloud proxy to monitor the endpoint and send monitored information to the first monitoring application running in the on-premises server or a second monitoring application running in a cloud-based server.

At 304, an operating system of the first virtual appliance may be modified based on a specification of the second virtual appliance. In an example, modifying the operating system may include modifying a version of the operating system based on the specification of the second virtual appliance. For example, an operating system upgrade package associated with a second version of the operating system may be deployed on the first virtual appliance. Further, the operating system of the first virtual appliance may be upgraded from a first version that supports the first functionality to the second version that supports the second functionality according to the operating system upgrade package.

In another example, modifying the operating system may include deploying an operating system installation package associated with another operating system on the first virtual appliance based on the specification of the second virtual appliance. Further, the operating system of the first virtual appliance that supports the first functionality may be transformed to the other operating system that supports the second functionality according to the operating system installation package.

At 306, a system variable may be provisioned in a persistent storage location accessible to the first virtual appliance based on the specification of the second virtual appliance. In an example, provisioning the system variable may include determining the system variable or the system variable with a different value required to perform the second functionality based on the specification of the second virtual appliance. Further, the system variable or the system variable with the different value may be stored in the persistent storage location accessible to the first virtual appliance.

At 308, an application specific package associated with the second functionality may be installed in the first virtual appliance. In an example, installing the application specific package associated with the second functionality may include modifying a hardware configuration of the first virtual appliance based on a hardware requirement of the second functionality. Further, the application specific package associated with the second functionality may be installed on the first virtual appliance upon modifying the operating system and the hardware configuration.

At 310, the first virtual appliance may be transformed to the second virtual appliance using the modified operating system, the provisioned system variable, and the application specific package. Further, the transformed first virtual appliance as the second virtual appliance may be rebooted to perform the second functionality. In an example, a boot script associated with the first functionality may be replaced with a boot script associated with the second functionality in the first virtual appliance. Further, the transformed first virtual appliance may be booted using the replaced boot script in response to a determination that the reboot of the first virtual appliance is a first boot of the first virtual appliance as the second virtual appliance.

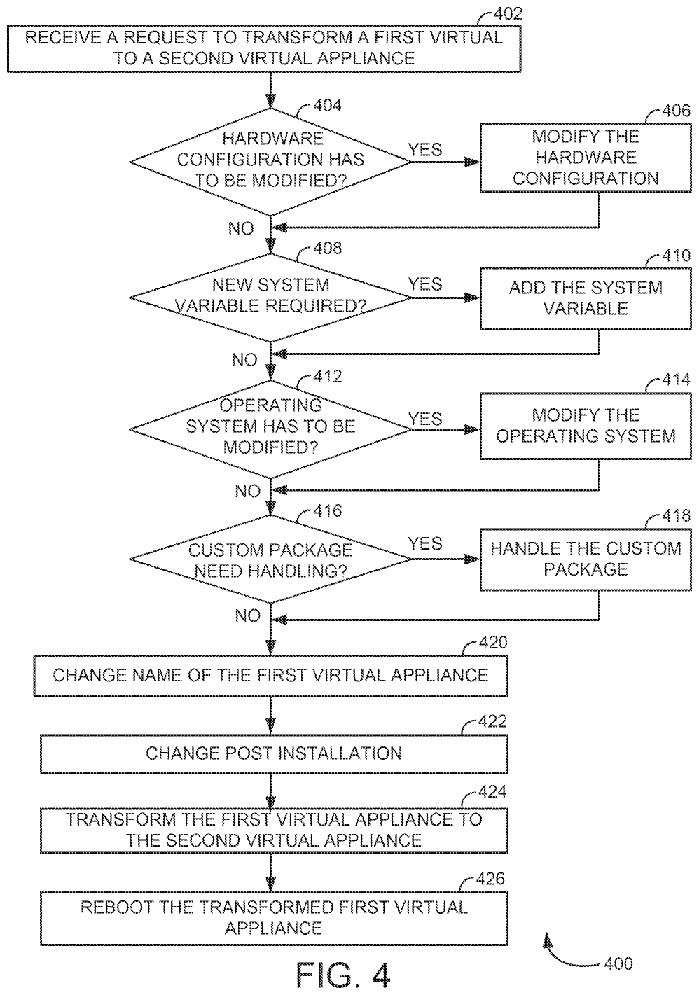

FIG. 4 is a flow diagram, illustrating another example method 400 for transforming a first virtual appliance having a first functionality to a second virtual appliance having a second functionality in a data center. At 402, a request may be received to upgrade the first virtual appliance (e.g., a source virtual appliance) having the first functionality to the second virtual appliance (e.g., a target virtual appliance) having the second functionality.

At 404, a check may be made to determine whether a hardware configuration of the first virtual appliance has to be modified based on a specification of the second virtual appliance. For example, the check is made to ensure the first virtual appliance meets the hardware requirements of the second virtual appliance. The hardware requirements can be, but not limited to, central processing unit (CPU), memory, storage, network interface cards (NICs), and the like. When the hardware configuration has to be modified, the hardware configuration of first virtual appliance may be modified, at 406. In an example scenario where an ARC is transformed to a cloud proxy, the ARC includes a disk storage of 40 GB. However, the cloud proxy may require the disk storage of 80 GB. In this example, before transforming the ARC to the CP, additional 40 GB disk space may be added. In another example, when the storage resource of the first virtual appliance is greater than what the required storage resource of the second virtual appliance, then a portion of the storage resource of the first virtual appliance can be relieved after the transformation process.

At 408, a check may be made to determine any new system variable is required based on the specification of the second virtual appliance. For example, the second virtual appliance may require a new set of system variables or variable with different values than the first virtual appliance. When the system variable is required, corresponding system variables and associated values may be added, at 410. In this example, the required system variables are stored in a persistent location that can be made available after upgrade of the first virtual appliance to the second virtual appliance. After upgrade and reboot of the first virtual appliance, the first virtual appliance may read the system variables from the persistent location. The following two ways can be used to make the system variables available after the upgrade. In an example, the system variables and corresponding values may be stored in a configuration file (e.g., va-profile.xml file). Upon transforming to the second virtual appliance, the system variables may be available in an Open Virtualization Format (OVF) file (e.g., /opt/vmware/etc/vami/ovfEnv.xml file). In another example, the system variables and corresponding values may be stored in the persistent location before upgrade. After upgrade, on reboot, the system variables may be read from “/opt/vmware/etc/vami/ovfEnv.xml” file. Thus, implementation related to the system variable update may have to be present in reboot or subsequent boot scripts of the first virtual appliance.

In an example scenario of transforming the ARC to the cloud proxy, the cloud proxy may need a special variable such as one time key (OTK) (e.g., a unique value for the cloud proxy), which may be binary-to-text encoded data (e.g., base64 encoded data) that has vROps SaaS master details (i.e., details of a monitoring application) to which the cloud proxy may have to establish a connection, send monitored information (i.e., performance metrics) to the monitoring application, and to listen for any control commands from the monitoring application.

At 412, a check may be made to determine whether an operating system of the first virtual appliance has to be modified based on the specification of the second virtual appliance. At 414, when the operating system of the first virtual appliance has to be modified, a version of the operating system is modified based on the specification of the second virtual appliance. In another example, an operating system installation package associated with another operating system may be deployed on the first virtual appliance based on the specification of the second virtual appliance. Thus, when the operating system of the first virtual appliance has to be modified, a different version of a common operating system or an entirely different operating system may be deployed based on the specification of the second virtual appliance. In an example scenario of transforming the ARC to the cloud proxy, the ARC includes Photon 1.0 operating system and the cloud proxy may require Photon 3.0 operating system. In this example, one level version upgrade may be skipped.

In some examples, there may be different sets or versions of operation system packages may be needed based on the specification of the second virtual appliance. In this example, details related to the operation system packages may be available in “va-profile. xml” under “<vadk:OSPackages>”. The required operating system packages of the second virtual appliance should be mentioned in the “va-profile.xml” of the first virtual appliance. Further, the operating system packages which were required for the first virtual appliance, but not needed for the second virtual appliance can be mentioned in “<vadk:PackagesToRemove>”. Furthermore, when the first virtual appliance is transformed to the second virtual appliance, the operating system packages mentioned in “<vadk:OSPackages>” may be installed and the operating system packages mentioned in “<vadk:PackagesToRemove>” may be removed.

At 416, a check may be made to determine whether a custom package needs handing based on the specification of the second virtual appliance. In an example, when an operating system package whose version is lower in latest operating system than older version of the operating system, upgrade of such package may be handled separately, at 418. In this example, the operating system of the first virtual appliance may be downgraded. For example, “</vadk:PrelnstallShellScript>” section of “va-profile.xml” may be updated using “rpm -Uvh <package-rpm>--nodeps - oldpackage”. Further, the packages may be removed from the package pool. For example, dbus and glib operating system packages may be handled separately.

In addition, custom packages upgrade of the first virtual appliance may be considered. The custom packages may include files related to an application corresponding to the second virtual appliance. For example, when the ARC has to be transformed to the cloud proxy, the ARC and the cloud proxy include a common custom package that has files and docker images. Further, the ARC and the cloud proxy include different files and a different number of docker images. The ARC may include 4 containers running on the ARC and the cloud proxy include one container running on the cloud proxy. In this example, the custom package may be upgraded.

At 420, name of the first virtual appliance may be changed as per the name of the second virtual appliance. For example, a product name of the first virtual appliance as per the name of the second virtual appliance in “va-profile.xml”. In an example transformation of the ARC to the cloud proxy, the name of the ARC is changed as the cloud proxy.

At 422, changes in post installation may be considered. For example, a post installation script may be used to have any services of the second virtual appliance to be enabled or initiated and to download a boot image (e.g., an ISO image) of the second virtual appliance. The ISO image may be available and mounted for initial boot of the first virtual appliance after transformation. In this example, the ISO image of the second virtual appliance can also be included as main build's components of the first virtual appliance. After the initial boot of the first virtual appliance after transformation, the boot image of the first virtual appliance can be removed.

At 424, the first virtual appliance may be transformed to the second virtual appliance using the modified hardware configuration, the modified operating system, the system variables, and the custom package. At 426, the transformed first virtual appliance may be rebooted. For example, after the transformation, when the first virtual appliance is rebooted, it is a first boot of the first virtual appliance as the cloud proxy. However, the boot is not the actual first boot of the first virtual machine. Actual first boot was when the ARC was deployed and booted for the first time. The first virtual appliance may include “<vadk:FirstBoot>” and “<vadk:SubsequentBoot>” sections which may hold a script that is executed on the actual first boot and the subsequent boot of the first virtual machine. Thus, in the “<vadk:FirstBoot>” of the first virtual appliance, the first boot script of the cloud proxy may be added. Further, in “<vadk:SubsequentBoot>”, a conditional block to check if it is the first boot of the first virtual appliance as the cloud proxy may be added and then the updated first boot section may be executed. If the boot is not the first boot as the cloud proxy, the subsequent boot of the cloud proxy may be executed. Also, when the first boot of the first virtual appliance is over as the cloud proxy, the ISO image may be unmounted and deleted. Further, a flag that the first virtual appliance is set to indicate the first boot as the cloud proxy is completed.

Example methods 300 and 400 depicted in FIGS. 3 and 4 represent generalized illustrations, and other processes may be added, or existing processes may be removed, modified, or rearranged without departing from the scope and spirit of the present application. In addition, methods 300 and 400 may represent instructions stored on a computer-readable storage medium that, when executed, may cause a processor to respond, to perform actions, to change states, and/or to make decisions. Alternatively, methods 300 and 400 may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate computer-readable instructions, or use a combination of hardware and computer-readable instructions to perform the illustrated processes.

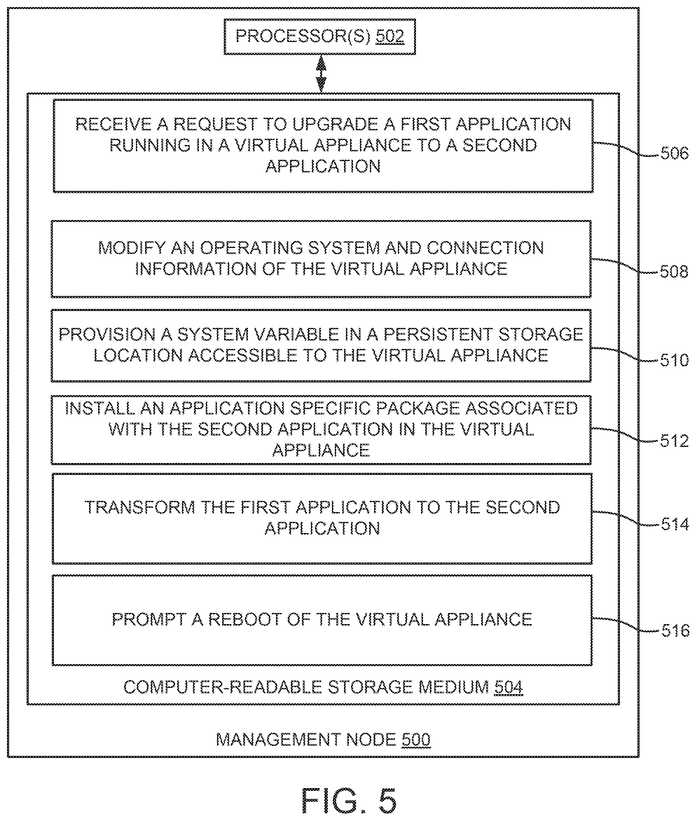

FIG. 5 is a block diagram of an example management node 500 including non-transitory computer-readable storage medium 504 storing instructions to transform a first application running in a virtual appliance to a second application. Management node 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to management node 500.

Machine-readable storage medium 504 may store instructions 506, 508, 510, 512, 514, and 516. Instructions 506 may be executed by processor 502 to receive a request to upgrade a first application running in a virtual appliance to a second application, the first application is to perform a first function in a data center. In an example, the first application acts as an application remote collector to monitor an endpoint in the data center and communicate monitored information to a first monitoring application running in an on-premises server. The second application may act as a cloud proxy to monitor the endpoint and communicate the monitored information to the first monitoring application or a second monitoring application running in a cloud-based server.

Instructions 508 may be executed by processor 502 to modify an operating system and connection information of the virtual appliance based on a specification of the second application. Instructions 510 may be executed by processor 502 to provision a system variable in a persistent storage location accessible to the virtual appliance based on the specification. In an example, the system variable includes a one-time key to establish a secure communication for the second application upon reboot of the virtual appliance.

Instructions 512 may be executed by processor 502 to install an application specific package associated with the second application in the virtual appliance. In an example, instructions 512 to install the application specific package include instructions to:
provision an additional storage resource to the virtual appliance based on a hardware requirement of the second application; and
install the application specific package associated with the second application on the virtual appliance upon modifying the operating system and provisioning the additional storage resource.

Instructions 514 may be executed by processor 502 to transform the first application to the second application using the modified operating system, application specific package, modified connection information, and provisioned system variable. Instructions 516 may be executed by processor 502 to prompt a reboot of the virtual appliance. The virtual appliance, upon reboot, may execute the second application to perform a second function in the data center.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computer-implemented method comprising:
receiving a request to upgrade, in a data center, a first virtual appliance having a first functionality to a second virtual appliance having a second functionality;
modifying an operating system of the first virtual appliance based on a specification of the second virtual appliance;
provisioning a system variable in a persistent storage location accessible to the first virtual appliance based on the specification of the second virtual appliance;
installing an application specific package associated with the second functionality in the first virtual appliance; and
transforming the first virtual appliance to the second virtual appliance using the modified operating system, the provisioned system variable, and the application specific package.

2. The computer-implemented method of claim 1, further comprising:
rebooting the transformed first virtual appliance as the second virtual appliance to perform the second functionality.

3. The computer-implemented method of claim 1, wherein modifying the operating system comprises:
modifying a version of the operating system based on the specification of the second virtual appliance.

4. The computer-implemented method of claim 3, wherein modifying the version of the operating system comprises:
deploying an operating system upgrade package associated with a second version of the operating system on the first virtual appliance; and
upgrading the operating system of the first virtual appliance from a first version that supports the first functionality to the second version that supports the second functionality according to the operating system upgrade package.

5. The computer-implemented method of claim 1, wherein modifying the operating system comprises:
deploying an operating system installation package associated with another operating system on the first virtual appliance based on the specification of the second virtual appliance; and
transforming the operating system of the first virtual appliance that supports the first functionality to the other operating system that supports the second functionality according to the operating system installation package.

6. The computer-implemented method of claim 1, wherein the first virtual appliance having the first functionality comprises an application remote collector to monitor an endpoint in the datacenter and send monitored information to a first monitoring application running in an on-premises server.

7. The computer-implemented method of claim 1, wherein the second virtual appliance having the second functionality comprises a cloud proxy to monitor an endpoint in the datacenter and send monitored information to a first monitoring application running in an on-premises server or a second monitoring application running in a cloud-based server.

8. The computer-implemented method of claim 1, wherein installing the application specific package associated with the second functionality comprises:
modifying a hardware configuration of the first virtual appliance based on a hardware requirement of the second functionality; and
installing the application specific package associated with the second functionality on the first virtual appliance upon modifying the operating system and the hardware configuration.

9. The computer-implemented method of claim 1, wherein provisioning the system variable comprises:
determining the system variable or the system variable with a different value required to perform the second functionality based on the specification of the second virtual appliance; and
storing the system variable or the system variable with the different value in the persistent storage location accessible to the first virtual appliance.

10. The computer-implemented method of claim 1, further comprising:
replacing a boot script associated with the first functionality with a boot script associated with the second functionality in the first virtual appliance; and
booting the transformed first virtual appliance using the replaced boot script in response to a determination that the reboot of the first virtual appliance is a first boot of the first virtual appliance as the second virtual appliance.

11. A system comprising:
a data center comprising:
an endpoint; and
a virtual appliance to execute a first application to perform a first function corresponding to the endpoint; and
a management node comprising instructions executable by a processing resource to:
modify a hardware configuration and an operating system of the virtual appliance based on a specification of a second application;
provision a system variable in a persistent storage location accessible to the virtual appliance based on the specification;
install an application specific package associated with the second application in the virtual appliance;
transform the first application to the second application using the modified hardware configuration, the modified operating system, and the application specific package; and
reboot the virtual appliance, wherein the virtual appliance, upon reboot, is to execute the second application to perform a second function corresponding to the endpoint using the provisioned system variable.

12. The system of claim 11, wherein the processing resource is to:
deploy an operating system upgrade package associated with a second version of the operating system on the virtual appliance; and
modify the operating system of the virtual appliance from a first version that supports the first application to the second version that supports the second application according to the operating system upgrade package.

13. The system of claim 11, wherein the endpoint comprises a physical host computing system, a virtual machine, or a container.

14. The system of claim 11, wherein the first application acts as an application remote collector to monitor the endpoint and communicate monitored information to a first monitoring application running in an on-premises server, and wherein the second application acts as a cloud proxy to monitor the endpoint and communicate monitored information to the first monitoring application running in the on-premises server or a second monitoring application running in a cloud-based server.

15. The system of claim 11, wherein the processing resource is to:
uninstall and delete an installation package associated with the first application upon transforming the virtual appliance.

16. The system of claim 11, wherein the processing resource is to:
download a boot image and a boot program associated with the second application to the virtual appliance; and
reboot the virtual appliance using the boot image and the boot program associated with the second application.

17. A non-transitory computer-readable storage medium storing instructions executable by a processor of a management node to:
receive a request to upgrade a first application running in a virtual appliance to a second application, the first application is to perform a first function in a data center;
modify an operating system and connection information of the virtual appliance based on a specification of the second application;
provision a system variable in a persistent storage location accessible to the virtual appliance based on the specification;
install an application specific package associated with the second application in the virtual appliance;
transform the first application to the second application using the modified operating system, application specific package, modified connection information, and provisioned system variable; and
prompt a reboot of the virtual appliance, wherein the virtual appliance, upon reboot, is to execute the second application to perform a second function in the data center.

18. The non-transitory computer-readable storage medium of claim 17, wherein the first application acts as an application remote collector to monitor an endpoint in the data center and communicate monitored information to a first monitoring application running in an on-premises server, and wherein the second application acts as a cloud proxy to monitor the endpoint and communicate the monitored information to the first monitoring application or a second monitoring application running in a cloud-based server.

19. The non-transitory computer-readable storage medium of claim 17, wherein instructions to install the application specific package comprise instructions to:
provision an additional storage resource to the virtual appliance based on a hardware requirement of the second application; and
install the application specific package associated with the second application on the virtual appliance upon modifying the operating system and provisioning the additional storage resource.

20. The non-transitory computer-readable storage medium of claim 17, wherein the system variable comprises a one-time key to establish a secure communication for the second application upon reboot of the virtual appliance.
